(19) United States
(12) Patent Application Publication
(10) Pub. No.: US 2006/0187623 A1
(43) Pub. Date: Aug. 24, 2006

(54) Retractable keyboard

(75) Inventor: Wen-Chieh Tseng, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ASUSTeK Computer Inc.

(21) Appl. No.: 11/342,738

(22) Filed: Jan. 30, 2006

(30) Foreign Application Priority Data
Feb. 22, 2005 (TW) 94105296

(51) Int. Cl. G06F 1/16

(52) U.S. Cl. 361/680; 248/917

(57) ABSTRACT

A retractable keyboard is described. The retractable keyboard is suitable for a handheld electrical device, and especially to a mobile phone with a personal digital assistant function. The retractable keyboard has a plurality of keyboard blocks coupling to an accommodating base of the handheld electrical device. Each of the keyboard blocks has parts of a complete keyboard. The expanded keyboard blocks form a whole keyboard having the same function and similar appearance dimensions of the complete keyboard, allowing convenient information key-in and control of the handheld electrical device. Only parts of the retractable keyboard are exposed for performing basic functions of the handheld electrical device when the retractable keyboard is retracted into the accommodating base.

### RELATED APPLICATIONS

The present application is based on, and claims priority from, Taiwan Application Serial Number 94105296, filed Feb. 22, 2005, the disclosure of which is hereby incorporated by reference herein in its entirety.

### FIELD OF THE INVENTION

The present invention generally relates to a retractable keyboard. More particularly, the present invention relates to a retractable keyboard of a mobile phone.

### BACKGROUND OF THE INVENTION

Due to great progress in wireless telecommunication technology, the mobile phone is a portably electrical device usable almost anytime and anywhere. The mobile phone has become an important information product in modern life.

Because of current widespread mobile phone use, mobile phone manufacturers devote all their resources to improve functions of the mobile phones for greater user satisfaction. For example, some mobile phones include a personal digital assistant (PDA) function, including, for example, functions of an address book, appointment scheduler, ToDo list, and journal. Some of the mobile phones further provide video games. Some may provide a digital camera function for taking pictures.

However, an interior space of the mobile phone is too tiny to accommodate all additional functions and structures therein. In particular, the dimensions of the mobile phone, generally smaller than a palm, are too small to accommodate a complete keyboard, e.g. a Qwerty keyboard, therein. Most of them only include a numerical keyboard for dialing the telephone number. Users can input English characters by pressing a numerical key multiple times to select a desired English character. The selection process on the numerical keyboard wastes operation time for character input and is so complex as to limit input speed.

Some mobile phone manufacturers design a complete keyboard on the mobile phone for convenient data input. However, the size of the conventional complete keyboard on the mobile is too small to input data conveniently. Some mobile phone manufacturers provide an additional external keyboard for data input so that users have to hand-carry, with added inconvenience, a mobile phone and the external keyboard. The inconvenient conventional keyboard for a handheld electrical device influences and limits the portability and convenience of handheld electrical devices.

### SUMMARY OF THE INVENTION

It is an objective of the present invention to provide a retractable keyboard for a handheld electrical device to improve the keyboard input efficiency of the handheld electrical device.

The present invention could provide a retractable keyboard with a touch pad for a handheld electrical device to control the handheld electrical device and input data with the touch pad.

The present invention could provide a rotatable display to demonstrate images with an aspect ratio similar to a desktop computer monitor so that users may control an electrical device and input data conveniently and effectively with the retractable keyboard.

The present invention could provide a rotatable accommodating base to accommodate a retractable keyboard and support a display by rotating the rotatable accommodating base.

To accomplish the above objectives, the embodiment of the present invention provides a retractable keyboard applied to a handheld electrical device such as, for example, a Smart phone, for conveniently inputting data into the Smart phone. The retractable keyboard includes a plurality of keyboard blocks storing on an accommodating component of the handheld electrical device. Each of the keyboard blocks has a part of a complete keyboard and the keyboard blocks cooperatively form the complete keyboard. One of the keyboard blocks is appeared by the accommodating component to perform a basic function of the handheld electrical device, e.g. a dialing function of a Smart phone.

Moreover, The keyboard blocks may connect to a touch pad for controlling the handheld electrical device by handwriting. The touch pad is stored on the accommodating component and can be appeared on the accommodating component to allow handwriting thereon. Accordingly, the touch pad may effectively reduce frequency of writing on the display so as to reduce the probability of scratching the display.

The handheld electrical device may utilize a wireless transmitting device, e.g. a blue tooth transmitting device or an infrared transmitting device, to communicate with the retractable keyboard. The retractable keyboard may be a foldable keyboard or a combination keyboard.

The accommodating component may be an accommodating base in which the retractable keyboard is stored. The display and the accommodating component of the handheld electrical device may be coupled together by a hinge, and the display can therefore rotate on the accommodating component. The display may further utilize a display pivot for changing an aspect ratio of the display, from a taller display to a wider display, and vice versa. The display may further include two speakers disposed on a left side and a right side of the display after the display is rotated about 90 degrees around the display pivot, so as to form a small multimedia computer.

Hence, the retractable keyboard according to the present invention can provide the handheld electrical device with a complete keyboard of similar dimensions and functions to complete keyboard so that users can easily and conveniently input English words and/or Chinese characters. When the retractable keyboard is stored on the accommodating component, parts of the retractable keyboard are still exposed to perform basic functions of the handheld electrical device.

### BRIEF DESCRIPTION OF THE DRAWINGS

The foregoing aspects and many of the attendant advantages of this invention are more readily appreciated as the same becomes better understood by reference to the following detailed description, when taken in conjunction with the accompanying drawings, wherein:

FIGS. 1A to 1D illustrate a preferred embodiment of a retractable keyboard according to the present invention.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

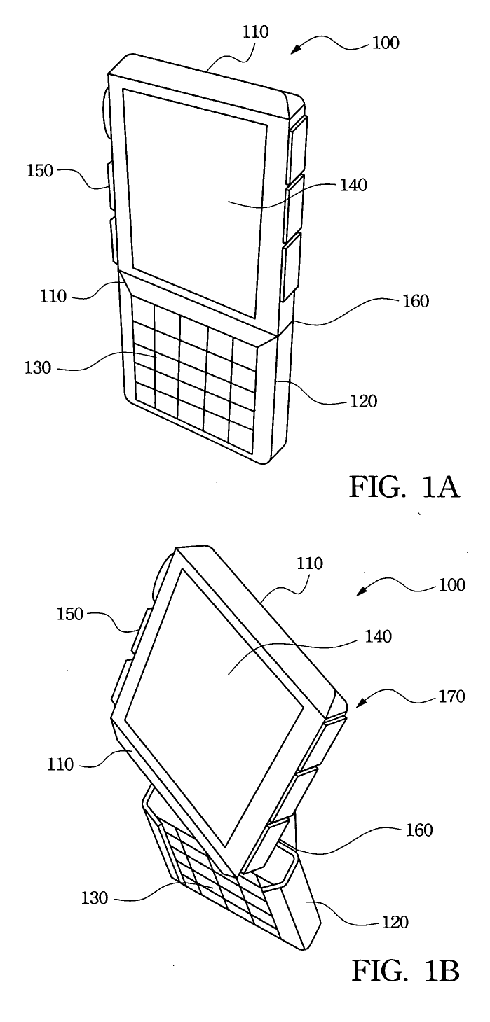

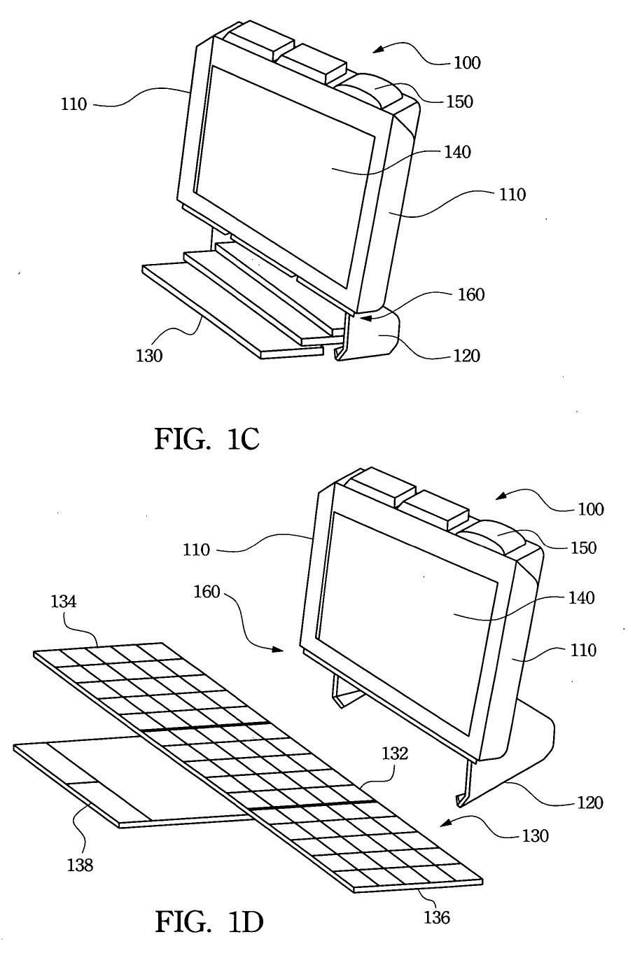

FIGS. 1A to 1D illustrate a preferred embodiment of a retractable keyboard according to the present invention. The retractable keyboard according to the embodiment is preferably utilized on a handheld electrical device, e.g. a Smart phone 100. Referring to the drawings, the Smart phone 100 includes a keyboard set 130, an accommodating base 120, and a display 140. Smart phone 100 includes the accommodating base 120 under the display 140. Users use the keyboard set 130 to perform basic functions, e.g. dialing a telephone number, of the Smart phone 100. The keyboard set 130 can be taken out from the accommodating base 120 and extended to form a complete keyboard for a complicated input.

Referring to FIG 1D, the keyboard set 130 is a complete keyboard composed of a first keyboard block 132, a second keyboard block 134 and a third keyboard block 136, and has dimensions similar to that of a normal computer keyboard for convenient data input. Users need not adapt to a small size keyboard for operating the Smart phone 100, thereby improving the input quality and efficiency of the Smart phone 100. The first keyboard block 132, the second keyboard block 134, and the third keyboard block 136 forms the complete keyboard by assembling or unfolding.

When the keyboard set 130 is a combination keyboard set, the first keyboard block 132, the second keyboard block 134, and the third keyboard block 136 can be taken apart or reassembled. In a basic operation, the keyboard set 130 couples to the accommodating base 120 and appears a single keyboard block, e.g. the first keyboard block 132, with a conventional mobile phone keys, such as 0-9, * and # keys. Therefore, users can easily dial telephone number with the appeared single keyboard block.

When the keyboard set 130 is a folding keyboard set, the first keyboard block 132, the second keyboard block 134, and the third keyboard block 136 can be folded and unfolded. In a basic operation, the folded keyboard set 130 couples to the accommodating base 120 and appear parts of the keyboard set 130, e.g. the first keyboard block 132, with a conventional mobile phone keys, such as 0-9, * and # keys. Therefore, users can easily dial telephone number with the appeared parts of the keyboard set 130.

When the keyboard set 130 is utilized to input complicated data, the keyboard set 130 can be extended to form a complete keyboard, having all Roman alphabet and numerical keys, similar to a computer keyboard. Users can easily input data with the complete keyboard, and do not need to learn a different input method or be restricted by a small keyboard, which may influence the input quality and efficiency.

The keyboard set 130 may further include a touch pad 138 coupling to the first keyboard block 132, the second keyboard block 134, and the third keyboard block 136 by assembling or unfolding. Users may directly use the touch pad 138 to input data by writing or to control the Smart phone 100 when the keyboard set 130 includes the touch pad 138. Therefore, the touch pad 138 may effectively reduce frequency of writing on the display 140 of the Smart phone 100 so as to reduce the probability of scratching the display 140.

The keyboard set 130 with the touch pad 138 can be accommodated on the accommodating base 120 and appears the touch pad 138 for writing thereon by hand. That is to say, the keyboard set 130 can utilize the touch pad 138 or any other keyboard block, 132, 134, or 136, to perform the basic functions of the Smart phone 100. Accordingly, the retractable keyboard according to the present invention can provide a convenient and fast input environment and various dialing methods for the Smart phone 100.

The display 140 is coupled to accommodating base 120 by a hinge 160. An angle between the accommodating base 120 and the display 140 can be adjusted by hinge 160. When using the complete keyboard to input data, the accommodating base 120 becomes a support base to support the display 140. In addition, the display 140 can rotate on a pivot 170 to change an aspect ratio, form a higher display to a wider display, and to provide a familiar aspect ratio for users or vice versa.

The keyboard set 130 can use a cable or a wireless, e.g. bluetooth or infrared rays, to electrically couple to the Smart phone 100 for transmitting required signals and data therebetween. The upper side and the bottom side of the display 140 may further include speakers 110 installed thereon to output audio signals, and the speakers 110 become a left stereo speaker and a right stereo speaker after the display 140 is rotated about 90 degrees. Control keys 150 can further provide quick operation modes or a search function to enable convenient operating and switching of the Smart phone 100.

Accordingly, the retractable keyboard according to the present embodiment can provide a numerical keys or a touch pad for a basic operation of the handheld electrical device, and can further provide a complete keyboard with a touch pad for complicated data input. With speakers installed on the display, the Smart phone further becomes a small multimedia computer and users can operate the computer with a familiar aspect ratio.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A retractable keyboard applied to a handheld electrical device with an accommodating component, comprising:
a plurality of keyboard blocks stored in the accommodating component, each of the keyboard blocks comprising a part of a complete keyboard and the keyboard blocks cooperatively forming the complete keyboard.

2. The retractable keyboard of claim 1, wherein the keyboard blocks further connect to a touch pad.

3. The retractable keyboard of claim 2, wherein the touch pad is appeared on the accommodating component for writing thereon by hand when the keyboard blocks are stored in the accommodating component.

4. The retractable keyboard of claim 1, wherein the retractable keyboard communicates with the handheld electrical device using a wireless transmitting device.

5. The retractable keyboard of claim 4, wherein the wireless transmitting device comprises a bluetooth transmitting device.

6. The retractable keyboard of claim 4, wherein the wireless transmitting device comprises an infrared transmitting device.

7. The retractable keyboard of claim 1, wherein the handheld electrical device is a mobile phone with a personal digital assistant (PDA) function.

8. The retractable keyboard of claim 1, wherein one of the keyboard blocks and the touch pad stored in the accommodating component are appeared on the accommodating component to perform a basic function of the handheld electrical device.

9. The retractable keyboard of claim 8, wherein the basic function of the handheld electrical device comprises dialing a telephone number.

10. The retractable keyboard of claim 1, wherein the keyboard blocks are folded in the accommodating component.

11. The retractable keyboard of claim 1, wherein the keyboard blocks are taken apart and stacked for receiving in the accommodating component.

12. A handheld electrical device with a retractable keyboard, the handheld electrical device comprising:
a display;
a hinge;
an accommodating base coupling to the display by the hinge to support the display at a predetermined angle by rotating the display along the hinge; and
a retractable keyboard, comprising:
a plurality of keyboard blocks stored in the accommodating component, each of the keyboard blocks comprising parts of a complete keyboard and the keyboard blocks cooperatively forming the complete keyboard.

13. The handheld electrical device of claim 12, wherein the keyboard blocks further connect to a touch pad for controlling the handheld electrical device easily.

14. The handheld electrical device of claim 13, wherein the touch pad is appeared on the accommodating component for writing thereon by hand when the keyboard blocks is stored on the accommodating component.

15. The handheld electrical device of claim 12, wherein the retractable keyboard communicates with the handheld electrical device using a wireless transmitting device.

16. The handheld electrical device of claim 12, wherein the handheld electrical device is a mobile phone with a personal digital assistant (PDA) function.

17. The handheld electrical device of claim 12, wherein one of the keyboard blocks and the touch pad stored on the accommodating component are appeared on the accommodating component to perform a basic function of the handheld electrical device.

18. The handheld electrical device of claim 17, wherein the basic function of the handheld electrical device comprises dialing a telephone number.

19. The handheld electrical device of claim 12, wherein the display further comprises a display pivot for changing an aspect ratio of the display, and two speakers disposed on a left side and a right side of the display after the display is rotated about 90 degrees around the display pivot.

20. The handheld electrical device of claim 12, wherein the keyboard blocks are folded in the accommodating base, or taken apart and stacked for receiving in the accommodating base.
